(19) United States
(12) Patent Application Publication
(10) Pub. No.: US 2019/0279077 A1
(43) Pub. Date: Sep. 12, 2019

(54) Neural Network Platform for Conscious Decision Making in Machines and Devices

(71) Applicant: Irvine Sensors Corp., Costa Mesa, CA (US)

(72) Inventor: John C. Carson, Corona del Mar, CA (US)

(73) Assignee: Irvine Sensors Corp., Costs Mesa, CA (US)

(21) Appl. No.: 15/813,232

(22) Filed: Nov. 15, 2017

Related U.S. Application Data
(63) Continuation-in-part of application No. 14/641,963, filed on Mar. 9, 2015, now Pat. No. 9,928,461.

(51) Int. Cl. G06N 3/063; G06N 3/04; G06N 3/08; G06N 5/04; G06K 9/62

(52) U.S. Cl. CPC G06N 3/063; G06N 3/04; G06K 9/6289; G06N 5/04; G06N 3/08

(57) ABSTRACT

To enable a conscious decision-making electronic neural network platform circuit, a neural network or a plurality of neural network layers is disclosed and configured to access to all sensor outputs. The platform is configured with access to stored memory of expected or anticipated sensor outputs, and to access the past signal output history in the context of similar or related activities and outcomes. Such configuration enables the neural network platform of the invention to function as a single entity to decide amongst available courses of action.

### CROSS-REFERENCE TO RELATED APPLICATIONS

This application is a continuation-in-part and claims the benefit of U.S. patent application Ser. No. 14/641,963, filed on Mar. 9, 2015 entitled “Hyper Aware Logic to Create an Agent of Consciousness and Intent for Devices and Machines”, which application is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of electronic neural networks. More specifically, the invention relates to an electronic neural network platform and device configured to receive and weight a very high number of parallel inputs from a variety of electronic sensor families and to output a result as a “winner take all” decision based on the weighted sensor inputs and related threshold values of the platform.

### 2. Description of the Related Art

Electronic neural networks are known in the prior art and are well-suited to learn and to perform processing tasks using a plurality of electronic neuronal and synaptic circuits, the inputs and outputs of which are parallel and very densely interconnected and which may be configured as one or more neuronal layers.

At a very general level, an electronic neuron is comprised of a plurality of electronic connections, each in the form of an electronic “synapse” that transmits an electronic signal to one or more other synapses of one or more other electronic neurons. The receiving or postsynaptic neuron may be configured to process a received signal and then relay or transmit the signal to one or more downstream neurons that are connected to it. Signals from the neurons or selected synapses of selected neurons may also have an associated weight that is variable (i.e., increases and decreases) as signal feedback and learning proceeds, which weight may result in the increase or decrease of the strength of the output signal that is transmitted to a receiving synapse of other neurons. Additionally, a predetermined set of signal threshold values may be provided such that a received signal is only transmitted to a receiving synapse of a connected neuron if it is equal to or above a certain level or value relative to the predetermined signal threshold.

The neuronal circuits comprising an electronic neural network may be organized in layers. Different layers may be configured to perform different types of transformations on their inputs. Signals may travel from a first input layer to a last output layer, possibly after traversing various neuronal layers multiple times depending on feedback configuration, signal thresholds and signal weighting.

An electronic neural network may receive inputs from the outputs of a sensorium comprising one or more sensor systems, e.g., a visible imager or focal plane array, a LIDAR, an audio, haptic, or motion sensor (e.g., a microphone, a pressure or temperature sensor, a gas or chemical sensor, or an accelerometer or gyroscope), and be configured to weight the values of the received sensor inputs according to a predetermined set of weighting values. The network may feedback selected outputs of certain neurons to selected inputs within the network and output a result based in part on the weighted values of the various sensor inputs. Each synapse in an artificial neural network may multiply a signed analog voltage by a predetermined or stored weight and generate a differential current that is proportional to the product of those values. The differential currents are summed on a set of bit lines and may be transferred through a sigmoid function, appearing at the neuron output as an analog voltage.

Exemplary electronic neural networks are disclosed in, for instance, U.S. Pat. No. 6,389,404, “NEURAL PROCESSING MODULE WITH INPUT ARCHITECTURES THAT MAKE USE OF WEIGHTED SYNAPSE ARRAY”, U.S. Pat. No. 5,235,672, “HARDWARE FOR ELECTRONIC NEURAL NETWORK”, and U.S. Pat. No. 8,510,244 “APPARATUS COMPRISING ARTIFICIAL NEURONAL ASSEMBLY”, the entirety of each of which is incorporated herein by reference.

### BRIEF SUMMARY OF THE INVENTION

To enable a conscious decision-making electronic neural network platform circuit, a neural network or a plurality of neural network layers is disclosed and configured to individually access all sensor outputs. The platform is further configured with access to stored electronic memory of expected or anticipated sensor outputs, and to store and access past signal output history in the context of similar or related activities and outcomes. Such a configuration enables the neural network platform of the invention to function as a single entity to decide among available courses of action.

The platform enables the addition of an agent of consciousness and intent to an artificial intelligence system that includes sensors, processors and controllers wherein said agent is composed of logic units for each sensor including each pixel of an imaging device, each frequency of a listening device and each output of any other sensor and wherein said agent can affect the behavior of the sensors, processors and controllers.

In a preferred embodiment, an apparatus to make machines and devices conscious and self-aware is disclosed comprising a sensorium comprising a plurality of sensors. Each of the sensors has a sensor output and a plurality of neuronal logic units which may comprise a stack of integrated circuit chip layers that are interconnected by through silicon vias. Each neuronal logic unit comprises a column of artificial neurons wherein the respective integrated circuit chip layers are separately devoted to the function of sensor inputs, word input, voting, communication, memory, and menu inputs. Each of the artificial neurons are synaptically interconnected within the column by one or more synapses that are configured to vary the strength of a connection between the artificial neurons based on a predetermined or learned weight received from a cerebral processor. A direct connection is provided between each of the sensor outputs within the machine or device and a corresponding neuronal logic unit. The neuronal logic units are configured to cluster and activate in response to the identification of an object, event, or behavior and the clustered neuronal logic units are interconnected and configured to jointly make choices on a winner takes all basis from a menu of choices provided by a host computational resource where the connection between each sensor and the neural logic can only be made when enabled by the host computational resource.

These and various additional aspects, embodiments and advantages of the present invention will become immediately apparent to those of ordinary skill in the art upon review of the Detailed Description and any claims to follow. While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE DRAWINGS

The embodiments herein are illustrated by way of example and not by way of limitation in the figures of the accompanying drawings in which like references indicate similar elements. It should be noted that references to “an” or “one” embodiment of the invention in this disclosure are not necessarily to the same embodiment, and they means at least one. Also, in the interest of conciseness and reducing the total number of figures, a given figure may be used to illustrate the features of more than one embodiment of the invention, and not all elements in the figure may be required for a given embodiment.

FIG. 1 is a block diagram showing a set major functional elements of a preferred embodiment of the invention.

FIG. 2 is a block diagram showing an architecture of a preferred embodiment of the invention.

FIG. 3 illustrates certain major elements of an exemplar chip set used in a preferred embodiment of the invention.

FIG. 4 illustrates a set of non-limiting exemplar applications for the platform of the invention.

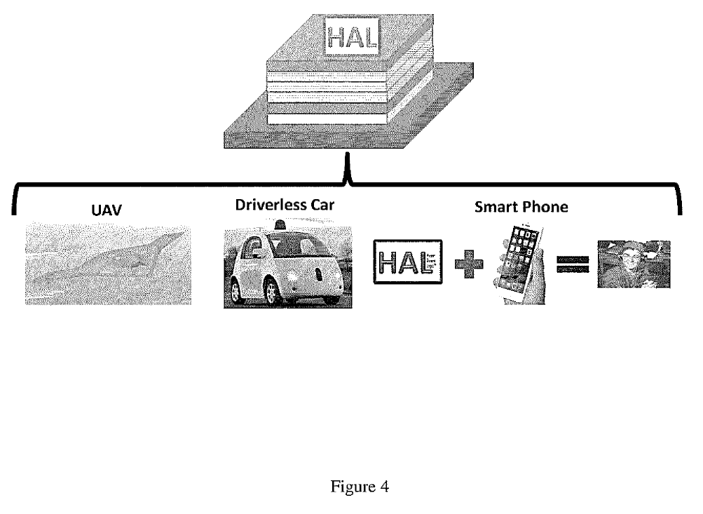

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures, the disclosed neural network platform enables conscious decision-making in machines and devices to replicate the human subjective experience, a richly aware, responsive decision-making performed within the response time of the platform's associated sensor systems; nominally about 30 milliseconds in humans. It is noted that conscious decision-making is not the same as object recognition, object labeling, representation, planning, forecasting, or action initiation, all of which are performed unconsciously in the human brain but are required to enable and configure machine consciousness.

Conscious decision-making more accurately refers to the executive function that overlays the above activities to enable real-time course correction based on expected or predicted results and prior experience. In robotics for instance, conscious decision-making enables performance and survival; with human augmentation, it keeps up with the immediate situation and provides timely and relevant assistance.

Conscious decision-making is important both at a human and machine level, in part because the details of a significant portion of many activities are planned unconsciously, prior to and in preparation of initiation of the activity itself.

Events that are coincident with or are in response to such activities require a response in real-time as soon as sensed. The response may entail everything from a change to another preexisting plan or resorting to an emergency response, e.g., fight or flight.

To enable a conscious decision-making electronic neural network platform circuit, a neural network or a plurality of neural network layers are used and configured to access all sensor outputs. The platform is further configured to access data in stored memory that is representative of expected, predicted or anticipated sensor outputs, and to access the past signal output history in the context of similar or related activities and outcomes. Such a configuration enables the neural network platform of the invention to function as a single entity to decide among a set of available courses of action.

A plurality of electronic sensor outputs from a sensorium or sensor suite, such as visible, SWIR, NIR, LWIR or other electromagnet sensors, audio, motion, acceleration, pressure, gas, chemical, temperature, gyroscopic, or other sensors capable of converting a physical quantity or measurement to an electronic signal are provided as inputs to the neural network, preferably on a 1:1 basis in order to affect the state of that element and synaptically in groups of sensor outputs related by recognition to associated network elements. For sensor elements such as imaging sensors that are provided in a two dimensional array (e.g., 2D array of pixels), preferably each individual sensor element or pixel output is provided with a dedicated neuronal input. Access to expected outputs and past sensor history are provided synaptically from data sets stored in platform memory to associated neuronal network elements.

The neural network layers of the invention are preferably organized as columns of artificial neurons having upper layers associated with pattern recognition and lower layers associated with decision making. These neural network elements are referred to as neuronal logic units herein.

To achieve awareness at maximum sensor resolution, each individual sensor output, e.g., each pixel in an image sensor, is provided with a dedicated respective individual neural network element. To achieve awareness at maximum sensor resolution, each individual sensor output, e.g., each pixel in an image sensor, is provided with a dedicated respective individual neural network element.

A sense of self is enabled by the configuration of the invention to perform “in-unison” collaborative decision-making that is executed by the neuronal logic units, the state of each of which is determined by its associated sensor output. The neuronal logic units are enabled by means of identification and labeling of the sensed object, event or activity occurring “subconsciously” in the circuitry.

The expected or predicted sensor outputs may be stored as data sets in electronic memory and communicated and received by the neuronal logic unit platform as “faux” or supplemental sensor inputs to the neurons via circuitry configured to emulate certain human thalamic nuclei signal routing functions.

As a result of the ability to perform conscious decision-making, the invention is thus able to substantially replace the human in the loop in a decision-making process in real-time with limited human supervision and direction.

Bilateral inputs are registered using a label and saccade, governed by attention.

Consciousness is extended to the individual sensor level, e.g., pixel level, because it equates to the human conscious experience and human consciousness uses such a level of granular resolution to detect and become aware of successes, problems or impending catastrophes.

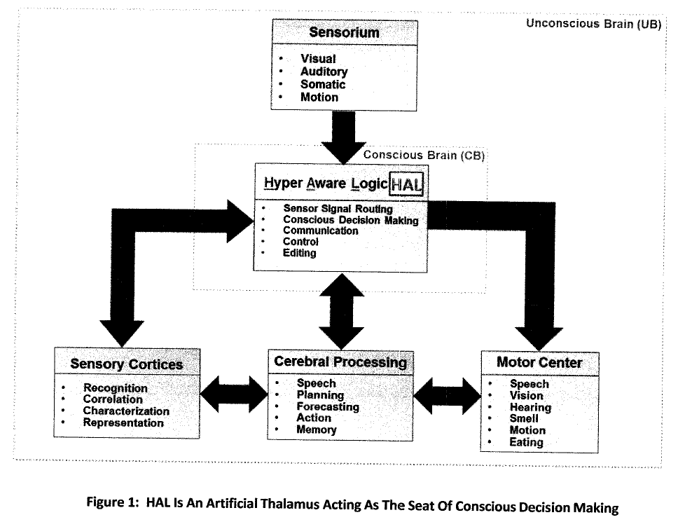

FIG. 1 illustrates a preferred embodiment of a model for emulating human conscious decision-making in the neural network platform of the invention, preferably residing primarily within a thalamic sensory nuclei circuit of the invention.

The sensorium of the invention may comprise sensors that emulate sensors in the human body except those involved in olfaction, which may have a separate pathway. The outputs of the sensors may all be received by the respective synapse circuitry of their respective thalamic nuclei circuitry. The invention is configured to emulate and execute the thalamic functions of the human brain for vision, auditory and somatic sensors, i.e., editing and routing these sensor outputs to the appropriate sensor processing cortices and performing conscious decision-making. Thalamic nuclei circuitry is provided in the invention to emulate the thalamic region of the brain which the only region where all human sensor outputs are simultaneously accessible and therefore, it is generally agreed within the neuroscience community to be the seat of consciousness. Therefor, a unique attribute of this invention is that it is also the agent of conscious decision-making with the ability to attend to external or internal stimuli, to identify the significance of such stimuli, and to plan a response to the stimuli.

The thalamic sensory nuclei circuit is configured to emulate the thalamic sensory nuclei in a human, i.e., to have a common architecture consisting of columns of neurons that each receive an individual sensor nerve ending both synaptically through dendrites and electrically at their bodies. Each neuron in the column communicates with the others and with thousands of other columns of neurons.

The thalamic nuclei associated with vision, the lateral geniculate nucleus (LGN), has a column for each optic nerve output and thalamic sensory nuclei circuit of the invention is provided with this function. Identical origins within the retina of each eye connect to the alternate two layers of the respective column. The thalumae from the two brain lobes sees only the left or right field of view hemisphere, all of which is important to the perception of depth and distance. There are about one million optic nerve connections to the human LGN from each eye.

The auditory pathway is somewhat more complex, there being intermediate nuclei along the way to the thalamus that connects to both ears and determines direction and can be used to focus attention ala the eye's saccade and foveate functionality.

The auditory nerve contains approximately 40,000 fibers, each passing a narrow bandpass frequency filtered signal from the cochlea. In addition, other nerve fibers transmit the onset of individual sounds. The thalamic destination for the auditory nerve is the medial geniculate nucleus (MGN), whose architecture closely resembles that of the LGN and which architecture is emulated in the thalamic sensory nuclei circuit of the invention.

Somatic sensors of a human include all of the heat, pain, and touch sensors in the skin, plus those that sense muscle contractions. Somatic nerve fibers synapse in the ventral posterior nucleus (VPN) of the thalamus with a very similar architecture. Motion sensors residing in the inner ear have nerve fibers that share the auditory path and wind up in both the MGN and VPN, the architecture of which is emulated in the thalamic sensory nuclei circuit of the invention.

The thalamus sensor circuitry is configured to emulate the above thalamic routing functions for the visual, auditory and somatosensory cortices and its outputs are routed on a one-for-one basis to the visual, auditory, and somatic cortices where recognition processing of the respective signals through recognition, labeling, characterization, and representation is performed.

Correlation of related objects, events, and activities are also performed by the thalamic circuitry and in the higher level cerebral processing. A broadly-used example of this processing in the artificial intelligence domain is referred to as a multi-layer deep learning algorithm. Feedback from the sensory cortices to the platform of the invention enables or switches on each neural column that corresponds to a label and clusters the related neural columns and consciousness is achieved. This process produces a minimum 300 milli-second latency that can only be overcome by conscious intervention.

A cerebral processing circuitry that emulates that of a human brain is provided and is where planning of speech, motion (actions), forecasting, and remote memory access occur. Forecasting, anticipating, or imagining is the creation of the anticipated next set of sensor outputs as a consequence of initiating a plan. Note that the human brain is capable of sustaining at least 50 parallel plans at once, but only one can be consciously overseen at any one time. The plan is initiated by directions to the motor centers which take action with very low latency. The imagined or anticipated results are transmitted sparsely to the neurons in the platform where they become synaptic weights in receptor fields that match actual with anticipated or expected results. Decision layers within each neural column in the platform see the patterns of matches and mismatches across all of the sensor outputs which have been clustered according to the plan under review.

These patterns are compared with comparable results and outcomes based upon their stored memory called up by the platform by the cerebral processing circuitry. The active subset of, in a non-limiting example, approximately four million neural columns comprising an exemplar platform, act in unison, on a winner-take-all voting basis, and decide the next step and communicate that to the motor and planning centers. This can be as simple as changing the focus of attention by a visual saccade, to the change of a sound being formed by speech organs, to a decision to flee or fight.

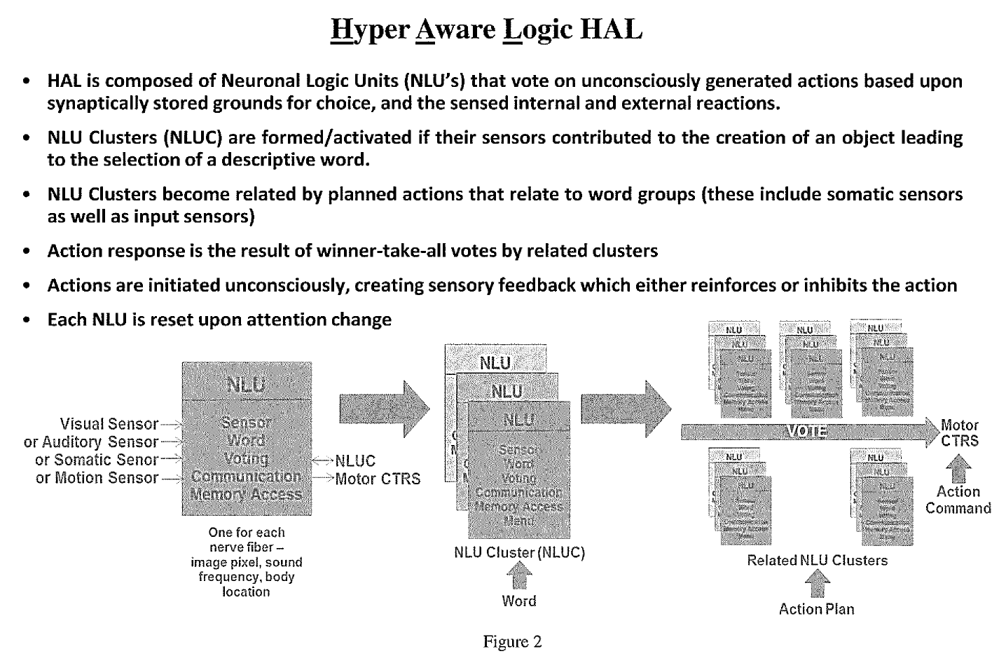

A preferred embodiment of an architecture of the neural network platform is illustrated in FIG. 2.

The basic building block is the neuronal logic unit (NLU) of FIG. 2 comprising a plurality of layers of artificial neurons and synaptic interconnects roughly equivalent to a cortical column in the brain. Using the vision system as an example, the decision process usually begins with a saccade shifting visual attention. Each neuronal logic unit is informed of the identity of any object it is viewing and all units viewing the same object are related into a cluster. Related clusters are grouped based upon activity and plan of action. As action is initiated unconsciously, the sensory feedback is compared to that which was expected based on stored data sets in memory, or perhaps to the previous value, and a judgment is reached, based upon prior experience or instruction, as to the desirability of the action.

The platform directly excites or inhibits the related motor center.

The platform is an assembly of highly interconnected columns of artificial neurons. Synaptic receptor fields consist of one layer of the sensor inputs to related sensor columns—related by sensor modality, label or plan—and four layers of column outputs. One of these four layers is a decision layer. Synaptic weights at each receptor field are established by planning forecasts and relevant memory and may require changing every sensor ‘frame time’ or about 30 milli-seconds. They may require changing at each attention shift, for example, a visual saccade. Receptor fields may involve 1,000-10,000 synaptic interconnects as does memory access. All of these receptor fields are basically multiply and add template matchers.

These connections do not provide awareness, particularly at the individual nerve ending or sensor level as this would defeat the objective of replicating the human conscious experience. To achieve the desired result requires a particular type of neuron design, one whose state and functionality are governed by the nerve end or sensor to which they are connected. Neurons are characterized by their spiking behavior where the spike amplitude and frequency (and potentially many other variables) very efficiently encode their results.

Spikes are generated when the input current exceeds a threshold and an output voltage (action potential) is triggered. An integrating trans-impedance amplifier is provided in the NLUs of the platform and performs in this way where the threshold and output voltage gain are controlled by externally generated voltages. The suggested approach to achieving awareness is to use the sensor nerve endings to provide this voltage to all of its column's neurons. Since all neural columns are connected in this way to all sensor outputs, the assemblage has become aware.

Decisions involve neural columns from all sensor modalities; therefore, the platform can only deal with one at a time, hence the need to focus attention. As will be seen, instantiation of the platform of the invention in hard-wired logic is at the edge of current mixed-mode CMOS technology, but is still straightforward. A software solution is not so straightforward, but is achievable using the concept of virtual neurons where within a 30 millisecond sensor frame time, the roughly forty billion synaptic interconnections are performed sequentially in a virtual neuron space, provided enough memory is available for all of the intermediate results.

The 3D Artificial Neural Network (3DANN), developed and demonstrated by Irvine Sensors Corp. in 1998-2000 is an electronic neural network capable of performing the above using special purpose ASICs. Today's GPUs provide adequate capability, albeit at kilowatt power levels which will obviate some applications.

Hardware instantiation of the platform of the invention begins with the design of the basic building block, the neuronal logic unit, preferably consisting of 4-6 neuron layers with interleaved synaptic connections. The top layer is configured to emulate the qualities of a spindle neuron, broadcasting its single sensor input to the other layers in its unit and to the other units in its cluster. The next layer is a neuron whose receptor field is all of the sensor inputs to its cluster and whose synaptic weights are either the expected value or the previous one, depending upon whether it is trying to detect deviation from expectation or simply change. The axonal output of this neuron goes to all of the NLU's in its cluster.

The next layer sees all of the outputs from all of the related clusters; note that at this level all of the sensorium is represented. The synaptic weights of this neuron are the learned good, bad, and neutral results from previous experience or as instructed from memory. Each neuron in this layer is its cluster's expert on a specific possible outcome. This layer may be replicated to provide a more diverse vocabulary of possible outcomes. The bottom layer sees all of the outputs from all of the preceding layers and collectively conducts a winner-take-all vote. Each layer can be laid out on a single integrated circuit chip and columns are formed by stacking the chips with synaptic interposers.

In a hardware or software system designed to mimic human decision-making capabilities, each layer may have as many neurons as there are sensor nerve fibers, approximately four million, and each may be synaptically interconnected to ten thousand other neurons in various layers and the unconscious brain.

Awareness is not provided by synaptic connections which essentially alter their values. It is directly felt by controlling the neuron's state and operation.

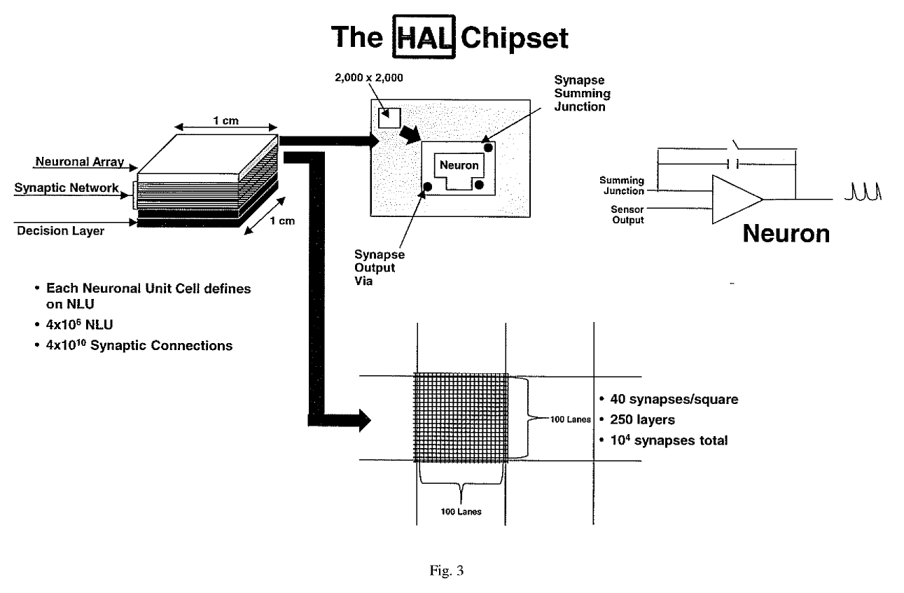

As shown in FIG. 3, the neuronal model is an integrate-and-dump transimpedance amplifier (i.e., current to voltage converter). When its threshold is exceeded, the integrated charge is dumped as an axonal spike whose value is a function of the transimpedance value, the spike frequency depends on the input magnitude. Both the threshold and transimpedance values are set by that neuron's associated sensor input. Since it acts as a single entity and collectively senses what its host sees, hears, and feels, the platform has all of the operational qualities of a sentient being.

The platform basically takes the human out of the real-time, in-the-loop position with obvious applications in driverless cars, remotely piloted drones, and surgery. In fields where the equipment is autonomous and the human is out of the real-time loop; such as robotics, unmanned vehicles, and combat systems—the invention raises the performance to equal or exceed manned systems.

In a parallel set of applications, machines or devices augment or assist humans. The invention can turn such instruments into the equivalent of another human that can be trusted and require only high level supervision. A cell phone is an excellent example.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

What is claimed:

1. An apparatus to make machines and devices conscious and self-aware comprising:
a sensorium comprising a plurality of sensors, each of the sensors having a sensor output;
a plurality of neuronal logic units comprising a stack of integrated circuit chip layers that are interconnected by through silicon vias;
each neuronal logic unit comprising a column of artificial neurons;
wherein the respective integrated circuit chip layers are separately devoted to the function of sensor inputs, word input, voting, communication, memory, and menu inputs;
each of the artificial neurons synaptically interconnected within the column by one or more synapses that are configured to vary the strength of a connection between the artificial neurons based on a predetermined or learned weight received from a cerebral processor,
a direct connection between each of the sensor outputs within the machine or device and a corresponding neuronal logic unit;
the neuronal logic units configured to cluster and activate in response to the identification of an object, event, or behavior; and;
wherein the clustered neuronal logic units are interconnected and configured to jointly make choices on a winner takes all basis from a menu of choices provided by a host computational resource and wherein the connection between each sensor and the neural logic can only be made when enabled by the host computational resource.
